(19) United States
(12) Patent Application Publication
(10) Pub. No.: US 2013/0347021 A1
(43) Pub. Date: Dec. 26, 2013

(54) ROAMING IN AN IPTV ENVIRONMENT

(71) Applicants: Donald Joong, Montreal (CA); Ola Andersson, Spamga (SE); Jean Drolet, (US); Stefan Paul Redmond, Pointe-Claire (CA)

(72) Inventors: Donald Joong, Montreal (CA); Ola Andersson, Spamga (SE); Jean Drolet, (US); Stefan Paul Redmond, Pointe-Claire (CA)

(21) Appl. No.: 13/529,386

(22) Filed: Jun. 21, 2012

(51) Int. Cl. H04N 21/25; H04H 40/00

(52) U.S. Cl. 725/25; 725/109

(57) ABSTRACT

An IPTV service provider makes use of a detection that a request for content cannot be fulfilled as a result of content distribution agreements as a trigger to select a roaming partner that is able to serve the requested content. The ITF making the request is redirected to the roaming partner to allow user requests to be served. This improves user experience and provides a potential new revenue source to the service provider.

### TECHNICAL FIELD

This disclosure relates generally to providing a roaming service to IPTV subscribers.

### BACKGROUND

Much like telephony services, transmission of television signals has evolved from analog transmission to digital transmission. Conventional television broadcast had a fixed location broadcast tower and a limit on the power level of the broadcast. This resulted in a fixed geographic area around the broadcast tower which could receive the transmissions. The area serviced by a television station could be expanded either through increasing the transmission power, or through the addition of a repeater.

As distribution of television signals became a more important sector, alternate delivery mechanisms were introduced including distribution through both cable and satellite networks. In cable distribution, a cable company provided a new distribution medium. Signals could be transmitted through the cable network, allowing the cable company to ensure a quality of picture for the analog transmission that over the air broadcasts could not. The cable company provided service to a fixed location, much as a telephone company provided phone service to a fixed address.

Satellite distribution made use of specialized receivers that received signals relayed from a ground station to a satellite, which then rebroadcast the signals. The signals transmitted by a satellite company are an over the air broadcast, but make use of digital transmission to allow the signals to be encrypted. The encryption allows for control of the user access. Satellite distribution relies upon the use of receiver dishes that are typically fixedly mounted to the exterior of a building.

As transmission of television signals has moved to the digital domain, it initially did not become mobile. One reason for this is the large amount of data that has to be transmitted, and the often the heavy computational load required to decode a television stream.

With the arrival of Internet Protocol Television (IPTV) and the availability of both improved encoding schemes and higher performance computing platforms in smaller devices, television transmission is truly becoming mobile. It is possible for a user to access television content anywhere that a data connection to the IPTV service provider is available.

Where mobile telephones were required to perform a roaming activity when they left the geographic footprint of the service provider network, no such equivalent requirement is present for IPTV users. From the perspective of the IPTV user, the access network may change, but the service provider can typically always be accessed.

FIG. 1 is a block diagram illustrating the how a mobile device obtains either telephony or data services in a home network, and also in a roaming network. A mobile device A1 100 is associated with carrier network A 102, and typically accesses the network 102 through a radio access network connection 104. Upon becoming active, mobile device A1 100 is registered to carrier network A 102 through a standard authentication process using data stored in the Home Subscriber Server (HSS) or Home Location Register (HLR) 106. Similarly, mobile device B1 108 is associated with carrier network B 112, and typically accesses the network 112 through a radio access network connection 110. Upon becoming active, mobile device B1 108 is registered to carrier network B 112 through a standard authentication process using data stored in the Home Subscriber Server (HSS) or Home Location Register (HLR) 114. When mobile device A2 116 leaves the geographic area served by carrier network A 102 it can connect, through radio access network connection 110 to carrier network B 112. To perform an authentication of mobile device A2 116, a connection 118 between carrier network B 112 and carrier network A 102 is employed. Mobile device A2 116 is authenticated against information stored in HSS/HLR 106 using standard mechanisms known in the art. In the above example, roaming onto carrier network B 112 is necessary to ensure service for mobile device A2 116 when it cannot connect to carrier network A 102 for what is often a geographic reason.

In an IPTV environment, as illustrated in FIG. 2, a display 122 is provided content by a set top box (STB) 124. STB 124 is typically implemented as a computing platform that provides an IPTV Terminal Function (ITF) that receives content from an IPTV service represented by IPTV Control Server 120, over a network such as Internet 126. The ITF decodes the received content and renders it for display to a user. As the access network used to connect to the internet 126 is not generally of concern, the notions of roaming services in an IPTV environment have not been fully considered. User roaming, as is known in the mobile telephony sense, has no such equivalent as the ability of the user to access the IPTV services is rarely associated with an ability connect to a particular access network. With the exception of purely managed networks, an IPTV subscriber can typically access a service provider over any access network connected to the Internet.

However, unlike a telephony network, the purpose of an IPTV service is not to create a communication session connecting a first user to second user. Instead the intent of an IPTV service is to provide a user access to content that has been generated by a third party. The creator of the content, or the party holding intellectual property rights, has often entered into agreements in different countries and jurisdictions that create legal encumbrances on the distribution of content. For example, the producer of a television program may have sold distribution rights in a first country to one of a plurality of different television networks or specialty channels; at the same time, the distribution rights for a second country may rest with another party. Thus, an IPTV service provider may not have the legal right to permit the delivery of content to a user in another country, even if the user has an account that would allow for access to the content in a home jurisdiction. Such a situation is illustrated in FIG. 3. A user in a jurisdiction A 128 can use STB 124, which is connected to the Internet, to connect to IPTV CS 120, and through this connection can be authenticated and authorized for access to content. The user may have a mobile device providing the services of ITF 132, such as a tablet computer or a laptop computer that is used during travel. One skilled in the art will appreciate that ITF can also be executed on an STB using credentials supplied by the user. The connection to IPTV CS 120 through Internet 126 can still proceed with no barriers to connection, and IPTV CS 120 can authenticate the user regardless of his presence in a different jurisdiction. This blindness to the geographic location of a user could result in the IPTV CS 120 allowing distribution of content to a location precluded from a distribution agreement.

To address these situations, some providers of online content often determine a coarse geographic location associated with a user through examining the IP address of any received requests. When requests are received from outside a specific geographic zone, they are simply rejected. In one example of this, many programs that are distributed in the United States of America by Comedy Central are distributed in Canada by The Comedy Network. Despite the similar name of these entities, they are distinct from each other, and a user attempting to access an IPTV service provider in the United States to watch The Colbert Report while visiting Canada, must be rejected, as Comedy Central's distribution rights for this content are geographically restricted.

The result of this balkanization of content distribution is a poor user experience. Users who have subscribed to IPTV services do not necessarily care about balkanized distribution territories. To a subscriber who is sitting in a remote hotel room, and has established a connection to an IPTV service provider, being told that content cannot be delivered due to geographical restrictions is, at best, frustrating. At worst, it is an invitation to the user either to engage the services of a remote proxy server with the intent of bypassing the geographic restrictions or to download the content from another source. Neither of these situations is helpful.

Users accessing an IPTV service expect the same mobility that has become a common expectation with mobile phones. There may be an understanding that accessing the content may come with a surcharge, but the outright denial of access to content will result in a diminished user experience.

Therefore, it would be desirable to provide a system and method that obviate or mitigate the above described problems

### SUMMARY

It is an object of the present invention to obviate or mitigate at least one disadvantage of the prior art.

In a first aspect of the present invention, there is provided a method for providing a user access to Internet Protocol Television (IPTV) content available from an IPTV service provider but not deliverable to the user by the IPTV service provider. The method comprises the steps of receiving, through a network interface, a connection request from an IPTV terminal function (ITF); determining that content requested by the ITF cannot be served to the ITF due to a content distribution restriction; and redirecting the ITF to an alternate service provider.

In an embodiment of the first aspect of the present invention, the method further includes the step of authenticating the ITF upon receiving the connection request. Optionally, the method can further include the steps of generating an authentication token on the basis of the authentication of the ITF for use by the alternate service provider; and transmitting the token to the alternate service provider. In a further embodiment, the step of transmitting the token is performed by sending the token to the ITF when redirecting the ITF to the alternate service provider. In another embodiment, the step of generating the authentication token includes generating the authentication token in conjunction with the alternate service provider. Optionally, the step of generating the token can include embedding service level information associated with the received connection request in a message along with the generated token. In another embodiment, the method includes the step of receiving a request to authenticate the generated token from the alternate service provider.

In another embodiment of the first aspect of the present invention, the method further includes the step of selecting the alternate service provider in accordance with data associated with the received connection request. In a further embodiment, the step of determining includes determining that the ITF is outside a geographic service boundary defined by a distribution agreement. In another embodiment, the method further includes a step of selecting the alternate service provider based on a geolocation associated with the ITF. In some embodiments, the geolocation is determined by inspecting an Internet Protocol address associated with the received connection request. Optionally, the geolocation is determined by receiving an explicit geolocation from the ITF. In another embodiment of the present invention, the method further includes a step of selecting the alternate service provider based on a mobile status value. Optionally, mobile status value is determined by inspecting the header of the received connection request for a mobile status indicator.

In a second aspect of the present invention, there is provided an Internet Protocol Television (ITPV) Server for providing a user access to IPTV content available from an IPTV service provider associated with the IPTV server but not deliverable to the user by the IPTV server. The server comprises an ITF interface, a compliance engine and a redirection engine. The IPTV Terminal Function (ITF) interface receives a request for content from an ITF, over a network. The compliance engine determines that the requested content cannot be served to the ITF due to a content distribution restriction. The a redirection engine selects an alternate IPTV service provider to deliver content to the ITF in accordance with the received request and a reason for determining that the requested content cannot be served, and provides redirection instructions to the ITF through the ITF interface.

In an embodiment of the second aspect of the present invention the IPTV server further includes an authenticator for authenticating the ITF upon receiving the connection request. In another embodiment, the server includes a token generator for generating an authentication token on the basis of the authentication of the ITF, the token for use by the alternate service provider, and for transmitting the generated token to the alternate IPTV service provider. Optionally, the server includes an alternate IPTV server interface for transmitting the generated token to an alternate IPTV server associated with the selected alternate IPTV Service provider. In another embodiment, the redirection engine is further adapted to transmit the generated token to the ITF when redirecting the ITF to the alternate IPTV service provider.

In another embodiment of the second aspect of the present invention, the compliance engine includes a geolocation engine that determines that the ITF is outside a geographic service boundary defined by a content compliance data stored in a memory operatively connected to the compliance engine. In another embodiment, the redirection engine is operatively connected to a memory to retrieve a list of alternate IPTV service providers for use in selecting the alternate IPTV service provider based on a geolocation associated with the ITF. In a further embodiment, the compliance engine includes a mobile status determination engine for determining a mobile status indicative that the ITF is embodied in a mobile device. In a further embodiment, the redirection engine is operatively connected to a memory to retrieve a list of alternate IPTV service providers for use in selecting the alternate IPTV service provider based on the determined mobile status of the ITF.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is block diagram illustrating a prior art network architecture for mobile phone roaming;

FIG. 2 is a block diagram illustrating a prior art IPTV network architecture;

FIG. 3 is a block diagram illustrating a prior art IPTV network architecture;

FIG. 4 is a block diagram illustrating a network architecture making use of an embodiment of the present invention;

FIG. 5 is a call flow diagram illustrating a method of an embodiment of the present invention;

FIG. 6 is a call flow diagram illustrating a method of an embodiment of the present invention;

FIG. 7 is a call flow diagram illustrating a method of an embodiment of the present invention;

FIG. 8 is a call flow diagram illustrating a method of an embodiment of the present invention;

FIG. 9 is a flow chart illustrating a method of an embodiment of the present invention;

FIG. 10 is a flow chart illustrating a method of an embodiment of the present invention;

FIG. 11 is a flow chart illustrating a method of an embodiment of the present invention;

FIG. 12 is a flow chart illustrating a method of an embodiment of the present invention;

FIG. 13 is a flow chart illustrating a method of an embodiment of the present invention;

FIG. 14 is a flow chart illustrating a method of an embodiment of the present invention;

FIG. 15 is a flow chart illustrating a method of an embodiment of the present invention;

FIG. 16 is a flow chart illustrating a method of an embodiment of the present invention;

FIG. 17 is a block diagram illustrating an embodiment of an IPTV server of the present invention; and

FIG. 18 is a block diagram illustrating an embodiment of an IPTV roaming service function of the present invention.

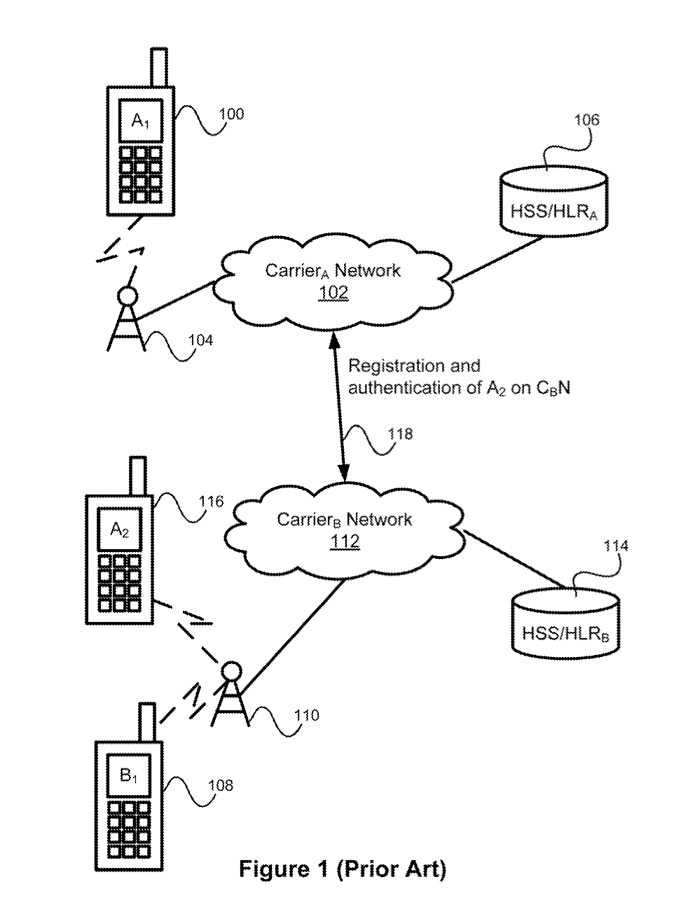

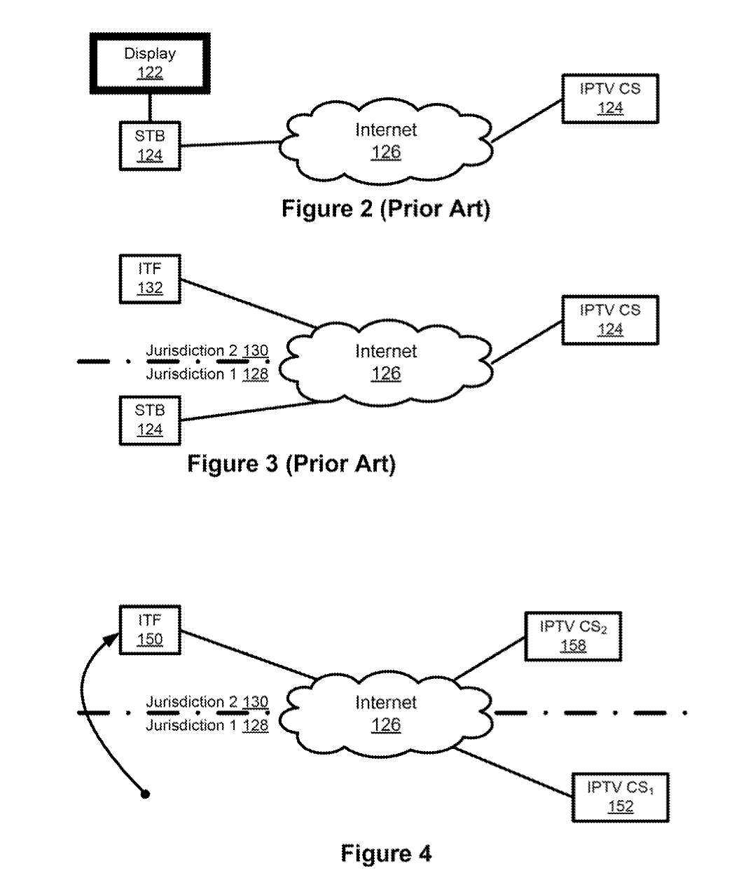

### DETAILED DESCRIPTION

The present invention is directed to a system and method for the provision of roaming services in an IPTV environment.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

There are legal encumbrances on the distribution of content based on a number of different factors. As discussed previously, geographic boundaries to distribution agreements have resulted in service providers denying service to subscribers or users based on a geographic location. This location is typically coarsely obtained by examining the IP address of the connection request. In the following discussion, an IPTV CS and a related method for execution on the IPTV CS that mitigate geographic connection problems discussed above. Such nodes and methods are also adapted for use in mitigating other problems attributable not to technical problems associated with network access rights, but instead to legal encumbrances such as those related to requests for mobile access while distribution rights are restricted to a non-mobile format.

Much as mobile telephony and data service providers created roaming agreements that allowed subscribers to leave the geographic footprint of the home network to roam within the footprint of a visited network, the following discussion assumes that an IPTV service provider will establish similar roaming agreements with IPTV service providers in other jurisdictions where content delivery is prohibited by the content distribution licenses. Such a system is shown in FIG. 4. A user of ITF 150 is registered with IPTV CS1 152 in Jurisdiction 1128. When the user visits Jurisdiction 2 130, and uses ITF 150 to connect to IPTV CS1 152 through Internet 126, IPTV CS1 152 can authenticate the user and then determine that the connection request is from outside the service area. Instead of denying service to the user of ITF 150, IPTV CS1 152 can redirect the connection request to IPTV CS2 154 with whom a roaming agreement is in place. This will result in ITF 150 connecting to IPTV CS2 154 to obtain service while in the jurisdiction in which IPTV CS2 154 has rights to distribute content.

It should be noted that the decision to redirect the ITF can be made at any of a number of points. Upon first receiving the connection request, IPTV CS1 152 can immediately redirect the request, allowing an authentication process to occur at IPTV CS2 154. Alternatively, ITF 150 can be redirected after authentication has occurred at IPTV CS1 152. The redirection request could be made after the user has requested delivery to a particular piece of content, so that the redirection decision can be made on a program by program basis as opposed to a blanket decision to redirect all users outside a defined geographic location. Those skilled in the art will appreciate that other factors can influence when in the process IPTV CS1 152 will determine that a redirection is required.

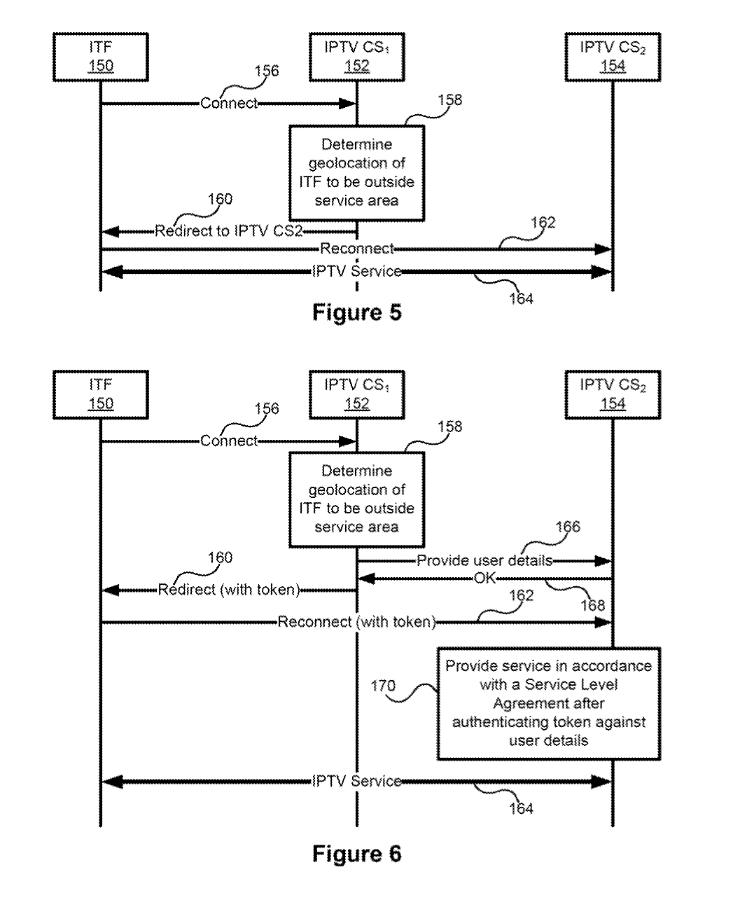

FIG. 5 is a message flow diagram illustrating an exemplary embodiment of messages sent in the establishment of a roaming IPTV session. ITF 150 sends a connection request 156 to IPTV CS1 152. In step 158, IPTV CS1 determines that geo-location associated with the request is outside a defined service area in which content can be delivered. In response to the determination of step 158, IPTV CS1 152 sends a message 160 to ITF 150 instructing ITF 150 to redirect the connection request to IPTV CS2 158. In step 162, ITF 150 issues a redirected connection request (referred to herein as a reconnect request) to IPTV CS2 154. Following reconnect request 162, IPTV service 164 is established between ITF 150 and IPTV CS2 154.

FIG. 6 illustrates an alternate embodiment, to the method of FIG. 5. Upon ITF 150 sending connect request and IPTV CS1 152 performing step 158 as described above, IPTV CS1 152 provides user details to IPTV CS2 154 in message 166. IPTV CS2 154 confirms receipt of message 166 in OK message 168. IPTV CS1 152 sends redirect message 160 as before, resulting in reconnection message 162 being sent as before. At this point, the user is authenticated by IPTV CS2 154. In message 160, ITF 150 can be provided a token that is used in the reconnect message 162. This token allows IPTV CS2 154 to authenticate ITF 150 against the user details provided to IPTV CS2 154 in message 166. In one embodiment, IPTV CS2 154 upon receiving the user details in message 166 generates a token that is provided to IPTV CS1 152 in OK message 168. Upon authentication of the user in step 170, IPTV Service 164 is established. One skilled in the art will appreciate that if the token is generated in IPTV CS1 152, it can be first sent to ITF 150 and then subsequently sent to IPTV CS2 154.

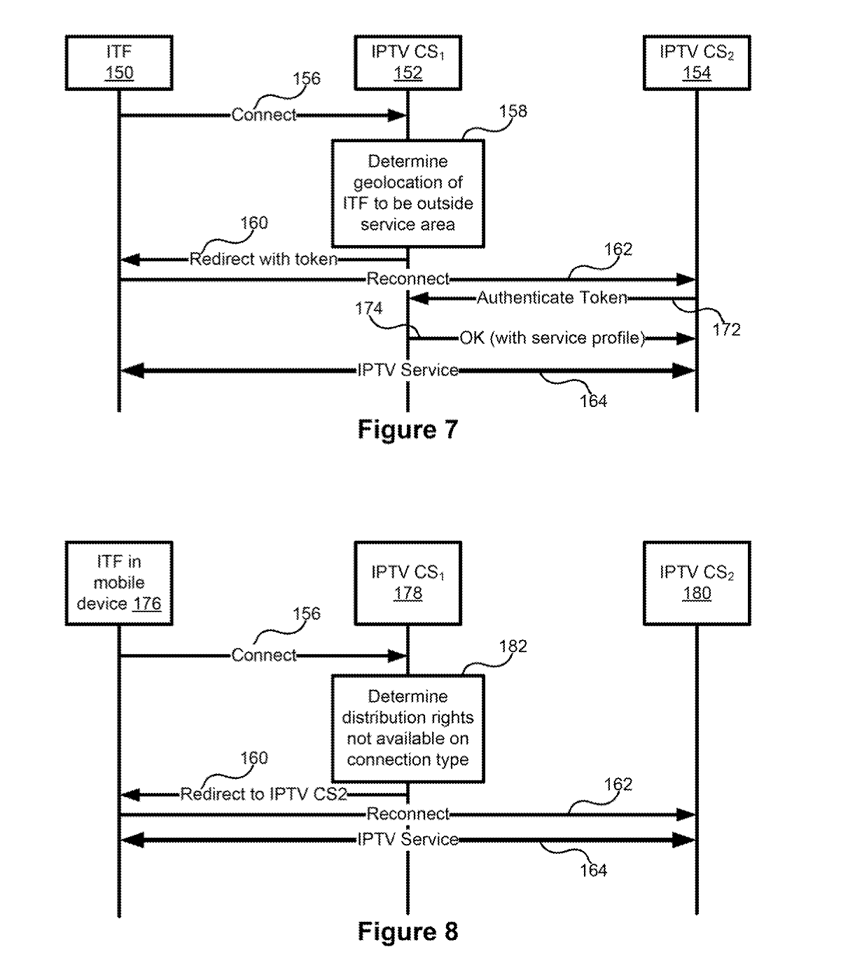

FIG. 7 illustrates a further alternate embodiment. Message 156 is sent from ITF 150 to IPTV CS1 152 as before, and step 158 is performed as described above. Redirect message 160 containing a token generated by IPTV CS1 152 is sent to ITF 150, which then issues reconnect message 162 to IPTV CS2 154. Along with the reconnect message 162, ITF 150 sends the token that was received from IPTV CS1 152 to IPTV CS2 152. Although the token is shown as being sent as a part of redirect message 160, those skilled in the art will appreciate that the token could be sent as a separate message. Upon receipt of the token, IPTV CS2 154 can issue a request 172 to IPTV CS1 152 to authenticate the token. Upon authenticating the token, IPTV CS1 152 can issue an OK message 174. OK message 174 can be accompanied (either embedded in the message or as an accompanying message) an indication of the service profile to be provided to ITF 150. Upon receipt of confirmation of authentication in OK message 174, IPTV Service 164 can be established.

Those skilled in the art will appreciate that different service agreements can be arranged between the entities operating IPTV CS1 and IPTV CS2. Thus, a subscriber to a certain IPTV channel line up with IPTV CS1 may not be provided with access to the same programming, but may instead be provided either the closest set of channels that match the subscription, or they may be offered a package of channels designated as appropriate to a roaming customer. It should be understood that the operator of IPTV CS2 may elect to offer more channels and additional content (such as Video on Demand (VOD) content, video games and other such content) to the user of ITF 150. If the user elects to pay more to obtain these services, a billing relationship can be setup between the carriers to allow the carriers to invoice each other for additional services in much the same way that mobile telephony carriers invoice each other for the provision of roaming services.

Those with an understanding of content distribution agreements will appreciate that there are a number of other encumbrances imposed by legal agreements. In addition to restrictions on the delivery of content based on geographic boundaries, there can also be legal encumbrances based on the type of platform that the content is delivered to. As an example, regardless of the access network used, there may be restrictions on delivering content to mobile devices. In the case of some events, mobile distribution rights are sold separately from fixed access distribution rights. Reference to mobile distribution should be understood as delivery to what are commonly considered as mobile platforms that can be easily distinguished as such. Such platforms include mobile phones, tablet computers and other media players, but likely do not include laptop computers. Often connection requests from mobile platforms are distinguishable at a server by information included in the header, such as an identification of a platform or browser identifier. FIG. 8 illustrates an exemplary embodiment of the handling of a connection request 156 sent from an ITF in a mobile device 178 to an IPTV CS1 178. Upon receipt of connection request 182, IPTV CS1 178 determines that the distribution rights are not available for the particular platform (optionally this can be based on both the platform and connection type) in step 182. As before a redirect message 160 is issued to mobile device ITF 176, prompting a reconnect message 162 sent to IPTV CS2 180 which is capable of handling the request from a mobile device. IPTV Service 164 is then initialized. One skilled in the art will appreciate that the variations to the flow of FIG. 5 can also be applied to the message flow of FIG. 8.

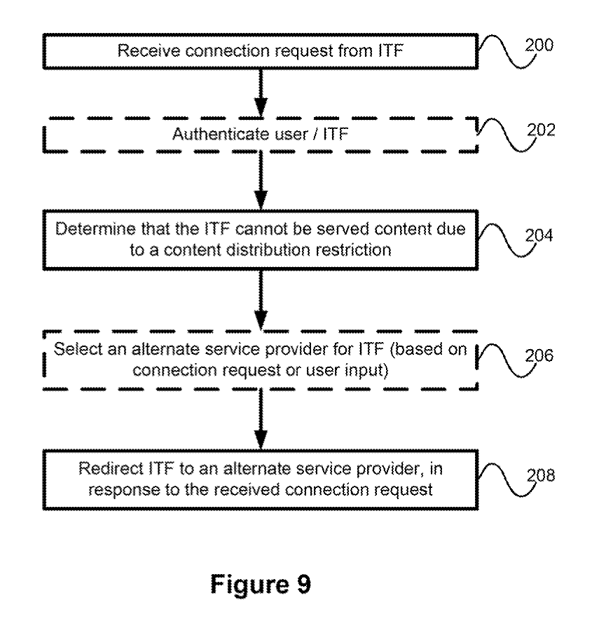

FIG. 9 is a flow chart illustrating method steps used in a method executed in a first IPTV CS that receives a connection request from an ITF. One skilled in the art will appreciate that where steps are described as being optional, they may be preferred for implementation in general but not required, they may be required for some implementations but not others, and they may provide advantages for execution at the illustrated point in the process, but may also be implemented at a later point. Not all of these characteristics will apply to each optional step, but this will be apparent to those of skill in the art.

As shown in FIG. 9, the process commences with receipt of a connection request from an ITF in step 200. Responsive to receipt of the connection request, the IPTV CS may optionally take the opportunity to authenticate the user. At this point, the IPTV CS can determine, in step 204, that the ITF cannot be served content due to a content distribution restriction. As noted above, the content distribution restriction is typically a legal encumbrance due to issues such as the connection type (mobile or non-mobile) or the geographic location of the ITF. In optional step 206, the IPTV CS can select an alternate service provider (with an associated IPTV CS) for the request from the ITF. This selection can be done in accordance with information associated with the connection request, such as a geolocation determined in accordance with the connection request or a platform type determined in accordance with header information in the connection request. In an alternate embodiment, the selection can be made in accordance with user input. In such an embodiment, a user can be determined to be outside a geographic boundary, and then be presented with a set of different services providers that can delivery content in a particular region, allowing the user to select which service provider to use. In step 208, the ITF is redirected to connection to the alternate service provider.

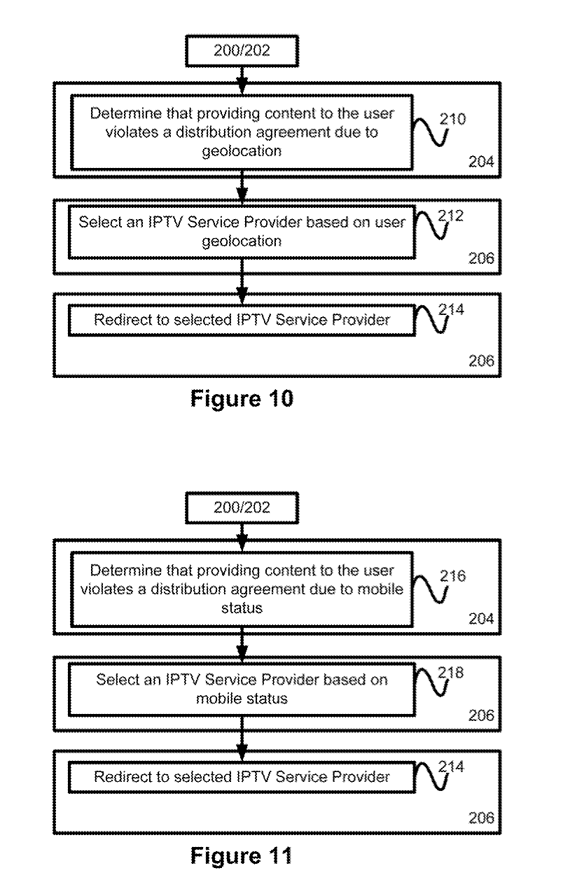

FIG. 10 illustrates an exemplary embodiment of the method of FIG. 9. Following step 200 (and optionally following step 202), the IPTV CS performs step 204, which in this embodiment includes determining, in step 210, that serving the user connection request would violate a distribution agreement due to user geolocation. The determination of the location of the user can be done in any of a number of different ways. As noted above with respect to the prior art, the geolocation can be determined coarsely using the IP address of the received request. In other embodiments, the geolocation of a user can be embedded in a request using such mechanisms as embedded GPS data associated with the platform sending the request. Following step 210, the IPTV performs step 210, which in this embodiment includes the selection of an IPTV Service Provider based on the user geolocation in step 212. As a part of step 208, the IPTV Server can then redirect the ITF to the selected IPTV Service Provider in step 214.

FIG. 11 illustrates another exemplary embodiment of the method of FIG. 9. As a part of step 204, the IPTV Server determines, in step 216, that a mobile status associated with the ITF violates a distribution agreement. As a part of step 206 the IPTV Server selects, in step 218, an IPTV Service Provider in accordance with the ITF mobile status. The process then continues on to step 208 with associated step 214 as described above with respect to FIG. 10.

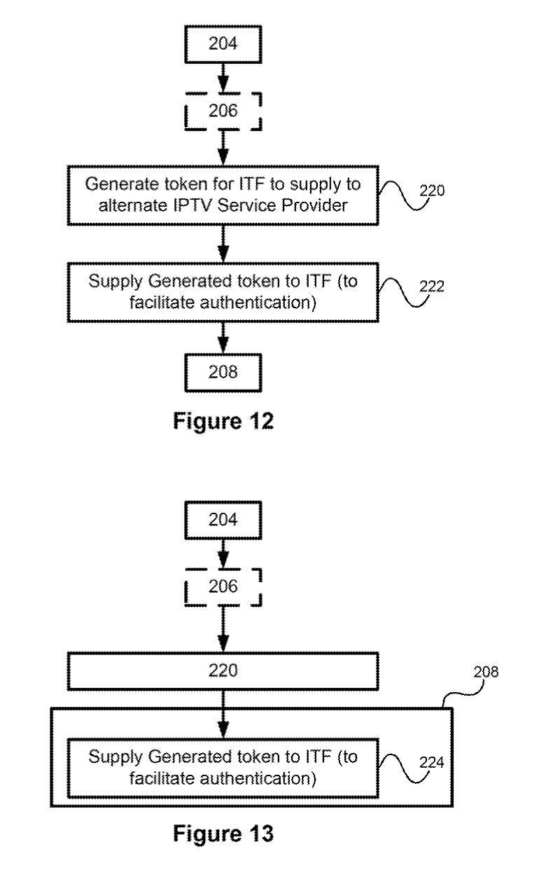

FIG. 12 illustrates an exemplary embodiment of the method of FIG. 9. Following step 204 (and optionally following step 206), the IPTV Server generates a token for the IRG to supply to the alternate IPTV service provider in step 220. The generated token is then provided to the ITF in step 222. This token can later be used to facilitate the ITF request at the alternate service provider. Following step 222, the method can continue as before with step 208.

FIG. 13 illustrates a further alternate embodiment, in which step 220 follows step 204 (and optionally step 206). Following step 220, and as a part of step 208 in which the ITF is provided a redirection instruction, the IPTV server can transmit the generated token as a part of the redirection request in step 224.

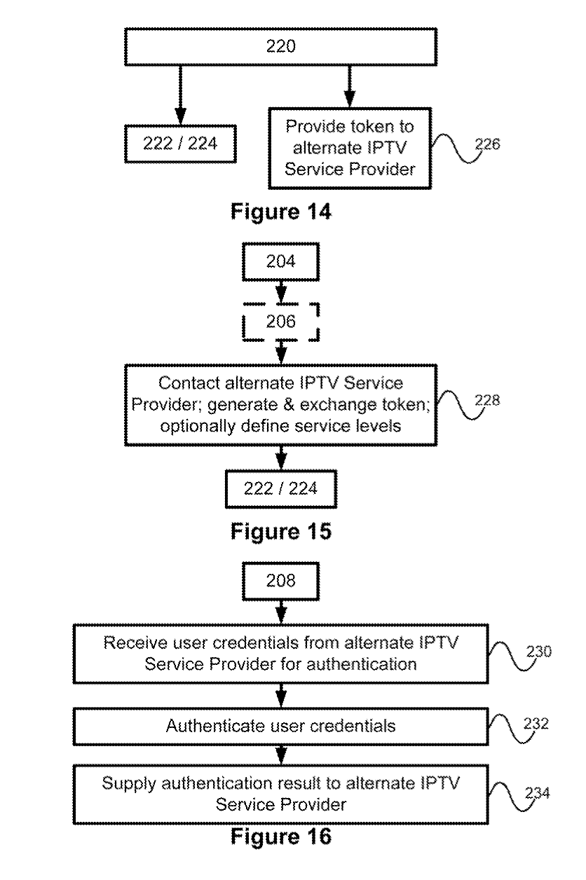

FIG. 14 illustrates a further embodiment of the method of FIG. 9. Following step 220 as described above, the IPTV server proceeds to either step 222 or 224, and additionally provides the token to the alternate IPTV Service Provider in a parallel path in step 226. There is no strict requirement for the order of the steps 222/224 and 226, but one skilled in the art will appreciate that step 226 is preferably performed before the ITF attempts to register with the alternate IPTV CS.

FIG. 15 illustrates a further embodiment of the method of FIG. 9. Following step 204, and optionally step 206, the IPTV server generates a token in conjunction with the alternate IPTV Service Provider. This token can then optionally be associated with defined service levels that are agreed upon between the IPTV Service Providers. Such service levels can be used to select what sort of content the redirected ITF will be provided as a default. Following step 228, the process can continue to step 222 or 224 and continue as shown in the above figures.

FIG. 16 illustrates a further embodiment of the method of FIG. 9. Following step 208, the IPTV server receives user credentials from the selected alternate IPTV server for authentication in step 230. In step 232, the user credentials are authenticated, and the authentication results are provided to the alternate IPTV server in step 234. In such an embodiment, the IPTV server does not provide the selected alternate IPTV Service Provider with a token that would allow the user of the ITF to be authenticated, or with a token indicating that the user of the ITF has been already authenticated. As a result, the alternate IPTV Service Provider will obtain user credentials and request that the home IPTV server will authenticate the user of the ITF.

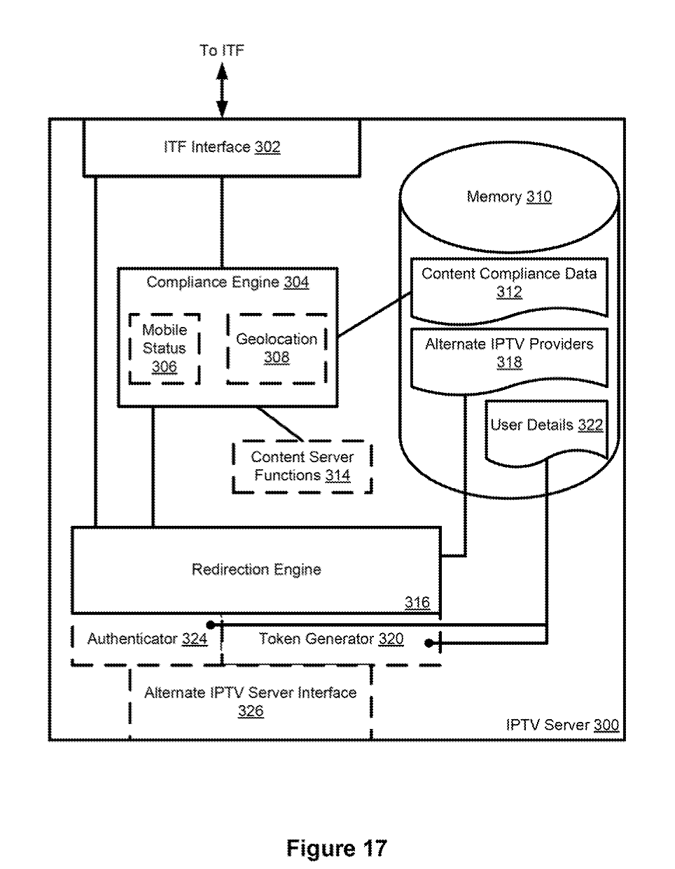

FIG. 17 illustrates an exemplary embodiment of an IPTV Server of the instant invention. One skilled in the art will appreciate that the functional elements can be implemented in any number of ways including software executed on general purpose hardware, hardware specific instructions turning general purpose hardware into special purpose hardware and in dedicated hardware. The IPTV Server 300 communicates with an IPTV Terminal Function (ITF) through ITF interface 302, which can in some embodiments be a conventional network interface. Requests for content received from the ITF, or login requests are provided to compliance engine 304 which determines if the request received from the ITF complies with distribution agreements. Compliance engine 304 is connected to a memory 310 which stores content compliance data 312 that can be general or specific to individual pieces of content. Content compliance data 312 is retrieved by compliance engine 304 and used in the determination of whether a received ITF request is compliant. This determination can be done in conjunction with optional elements such as mobile status validation engine 306 and geolocation validation engine 308. Engines 306 and 308 can be used to determine mobile status and geolocation information associated with the ITF request through any number of means including parsing the request for particular information and comparing it to rules provided in the content compliance data 312. If the content compliance rules are determined to be satisfied by compliance engine 304, the ITF request can be forwarded to the content server functions 314 of a conventional IPTV Server. If the compliance rules are not determined to be satisfied by the compliance engine 304, an indication is provided to the redirection engine 316 which, in conjunction with a listing 318 of alternate IPTV Providers retrieved from memory 310, determines which IPTV Provider the ITF should be redirected to, and sends the redirection request to the ITF through ITF interface 302.

One skilled in the art will appreciate that in some embodiments the determination of the IPTV provider that the ITF should be redirected to is done in accordance with a determination of whether the ITF is connected through a mobile device, which is preferably indicated by the compliance engine 304. In other embodiments, the determination is done in accordance the geolocation of the ITF, which again is information preferably indicated by the compliance engine 304. In some embodiments, the determination is done in accordance with both the mobile status and the geolocation. It should also be apparent to those skilled in the art that more than one alternate IPTV provider can satisfy the conditions associated with the ITF request. In such a case, the redirection engine 316 can either select an IPTV provider based on business specific rules, or the user can be provided a selection of IPTV providers to be redirected to.

Redirection engine 316 may optionally include a token generator 320 which can generate the tokens discussed with respect to earlier flowcharts. The tokens can be generated in accordance with user data 322 obtained from memory 310, and may optionally be generated in accordance with the identity of the selected IPTV provider, furthermore, the token may be generated in accordance with a communication with the selected IPTV provider. The token may include information such as the level of service that should be provided to the user, and an identification of how the token can be authenticated. The redirection engine 316 may later be presented with a token for authentication, which can be done by optionally implemented token authenticator 324. Any number of token authentication mechanisms can be employed that will be well understood by those skilled in the art.

Where IPTV Server 300 communicates with an alternate IPTV server through a back channel instead of through messages relayed by the ITF, an alternate IPTV Server interface 326 may be used. In many embodiments alternate IPTV Server interface 326 is used to transmit tokens generated by token generator 320, and to receive and respond to authentication requests directed to authenticator 324. Where the backchannel communication is used without a token, the alternate IPTV Server Interface 326 can receive requests for user credential authentication from another IPTV server, and provide the received credentials to Authenticator 324, which can make use of stored user details 322 to provide an authentication service.

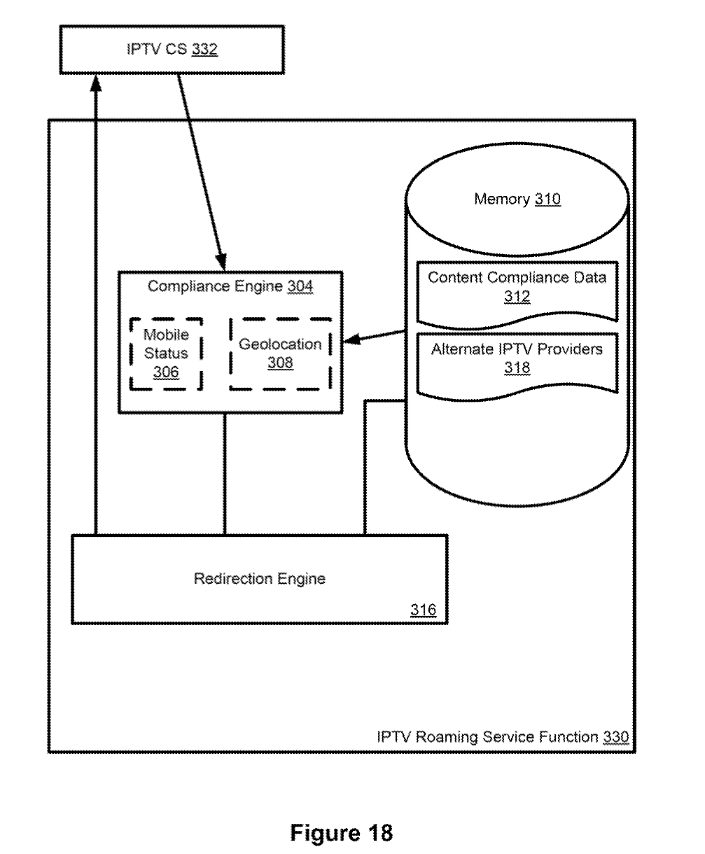

One skilled in the art will appreciate that a conventional IPTV server may be employed without the modifications illustrated in FIG. 17, and instead the IPTV server may employ an IPTV Roaming Service Function 330 as illustrated in FIG. 18.

IPTV Roaming Service Function 330 includes compliance engine 304 which may optionally include mobility status determination engine 316 and geolocation determination engine 308 as discussed with respect to FIG. 17. Memory 310 contains content compliance data 312 and a list of alternate IPTV Providers 318. Compliance engine 304 receives a request from IPTV server 332 to confirm that a user request for content does not violate a distribution agreement. In accordance with data associated with the received request, the compliance engine 304 makes a determination of whether a request can be served or not. If the request can be served, compliance engine 304 can provide such an indication back to IPTV server 332. In the alternate, where the request would violate the compliance rules obtained from content compliance data 312, compliance engine 304 can involve Redirection engine 316. Redirection engine, in accordance with the information provided by compliance engine 304 and the list of alternate IPTV providers 318, selects an IPTV provider (or possibly a set of IPTV service providers) that can serve the user the requested content, and provides the selection to the IPTV server 332. If a plurality of IPTV Service providers is returned to the IPTV server 332, the IPTV Server 332 can then either select one of the plurality of IPTV service providers and instruct the requesting ITF to redirect, or it can provide the requesting ITF with the a list of IPTV Service Providers that can serve the requested content and allow the user to select a provider from the list.

One skilled in the art will appreciate that the IPTV Roaming Service Function need not be uniquely associated with a single IPTV Server, and instead can provide this functionality to a plurality of different IPTV service providers. In such a case, the redirection engine 306 and the compliance engine 304 are preferably made aware of the IPTV Service Provider making the request, and the decision on compliance and selection of alternate IPTV Service providers are made in accordance with that information.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

1. A method for providing a user access to Internet Protocol Television (IPTV) content available from an IPTV service provider but not deliverable to the user by the IPTV service provider, the method comprising:
receiving, through a network interface, a connection request from a user through an IPTV terminal function (ITF), the user having an account with the service provider;
determining that content requested by the ITF cannot be served to the ITF due to a content distribution restriction; and
redirecting the ITF to an alternate service provider with which the user does not have an account.

2. The method of claim 1 further including the step of authenticating the ITF upon receiving the connection request.

3. The method of claim 2 further including the steps of:
generating an authentication token on the basis of the authentication of the ITF for use by the alternate service provider; and
transmitting the token to the alternate service provider.

4. The method of claim 3 wherein the step of transmitting the token is performed by sending the token to the ITF when redirecting the ITF to the alternate service provider.

5. The method of claim 3 wherein the step of generating the authentication token includes generating the authentication token in conjunction with the alternate service provider.

6. The method of claim 3 wherein the step of generating the token includes embedding service level information associated with the received connection request in a message along with the generated token.

7. The method of claim 3 further including the step of receiving a request to authenticate the generated token from the alternate service provider.

8. The method of claim 1 further including the step of selecting the alternate service provider in accordance with data associated with the received connection request.

9. The method of claim 1 wherein the step of determining includes determining that the ITF is outside a geographic service boundary defined by a distribution agreement.

10. The method of claim 9 further including a step of selecting the alternate service provider based on a geolocation associated with the ITF.

11. The method of claim 10 wherein the geolocation is determined by inspecting an Internet Protocol address associated with the received connection request.

12. The method of claim 10 wherein the geolocation is determined by receiving an explicit geolocation from the ITF.

13. The method of claim 9 further including a step of selecting the alternate service provider based on a mobile status value.

14. The method of claim 13 wherein the mobile status value is determined by inspecting the header of the received connection request for a mobile status indicator.

15. An Internet Protocol Television (ITPV) Server for providing a user access to IPTV content available from an IPTV service provider associated with the IPTV server but not deliverable to the user by the IPTV server, the server comprising:
an IPTV Terminal Function (ITF) interface for receiving a request for content from the user through an ITF, over a network, the user having an account with the IPTV service provider;
a compliance engine for determining that the requested content cannot be served to the ITF due to a content distribution restriction; and
a redirection engine for selecting an alternate IPTV service provider with which the user does not have an account, to deliver content to the ITF in accordance with the received request and a reason for determining that the requested content cannot be served, and for providing redirection instructions to the ITF through the ITF interface.

16. The IPTV Server of claim 15 further including an authenticator for authenticating the ITF upon receiving the connection request.

17. The IPTV Server of claim 16 further including a token generator for generating an authentication token on the basis of the authentication of the ITF for use by the alternate service provider and for transmitting the generated token to the alternate IPTV service provider.

18. The IPTV Server of claim 17 further including an alternate IPTV server interface for transmitting the generated token to an alternate IPTV server associated with the selected alternate IPTV Service provider.

19. The IPTV Server of claim 17 wherein the redirection engine is further adapted to transmit the generated token to the ITF when redirecting the ITF to the alternate IPTV service provider.

20. The IPTV Server of claim 15 wherein the compliance engine includes a geolocation engine for determining that the ITF is outside a geographic service boundary defined by a content compliance data stored in a memory operatively connected to the compliance engine.

21. The IPTV Server of claim 20 wherein the redirection engine is operatively connected to a memory to retrieve a list of alternate IPTV service providers for use in selecting the alternate IPTV service provider based on a geolocation associated with the ITF.

22. The IPTV Server of claim 15 wherein the compliance engine includes a mobile status determination engine for determining a mobile status indicative that the ITF is embodied in a mobile device.

23. The IPTV Server of claim 22 wherein the redirection engine is operatively connected to a memory to retrieve a list of alternate IPTV service providers for use in selecting the alternate IPTV service provider based on the determined mobile status of the ITF.
